(19) United States
(12) Patent Application Publication
(10) Pub. No.: US 2025/0388167 A1
(43) Pub. Date: Dec. 25, 2025

(54) MOTOR VEHICLE WITH A LIGHTING DEVICE

(71) Applicant: AUDI AG, Ingolstadt (DE)

(72) Inventors: Lars ELLERMANN, Weinsberg (DE); Steffen ROSS, Wettstetten (DE)

(73) Assignee: AUDI AG, Ingolstadt (DE)

(21) Appl. No.: 19/189,740

(22) Filed: Apr. 25, 2025

(30) Foreign Application Priority Data
Jun. 24, 2024 (DE) 102024117695.4

(51) Int. Cl. B60Q 3/267; B60Q 3/60

(52) U.S. Cl. CPC B60Q 3/267; B60Q 3/60

(57) ABSTRACT

A motor vehicle with a lighting device arranged on the motor vehicle. The lighting device has two flat reflection elements which are aligned with one another in such a way that their reflecting surfaces face one another and form an intermediate space. The first reflection element is arranged in a first reflection plane of the lighting device, and the second reflection element is arranged in a second reflection plane and is spaced from the first reflection element. The second reflection element is partially transparent. The first reflection element is arranged on the motor vehicle, and the lighting device has at least one lighting element which is arranged in the intermediate space in such a way that, when switched on, it emits light onto at least one of the two reflection elements. The lighting device forms a light strip.

### FIELD

The invention relates to a motor vehicle with a lighting device arranged on the motor vehicle. The lighting device can, for example, be arranged on an outside of the motor vehicle, or preferably in the interior.

### BACKGROUND

Nowadays, in order to showcase the vehicle interior, direct or indirect light is used to illuminate lines, edges or surfaces. In recent years, there has been an increasing trend towards vehicle interior lighting, especially ambient lighting.

DE 10 2018 211 747 B4 describes a display device for a motor vehicle with at least one electronic display, with a first mirror and a second mirror arranged at a distance therefrom, wherein the two mirrors are arranged such that they are arranged so as to overlap at least in some regions when viewed by projection onto both mirrors. In the overlapping region, an intermediate space is formed between the mirrors. This display device has at least one light source which is arranged in such a way that its light can be emitted into the intermediate space and can be reflected there several times by the mirrors to produce an endless mirror effect, so that in a single image plane of the display device an image with a light pattern appearing to have an optical depth effect is created for an observer. Optical image information generated by the electronic display is reflected into the image plane via the first mirror, so that the optical image information is displayed in the image in addition to the light pattern.

The basic principle of endless mirrors is described, for example, in the documents DE 162822 U, WO 2023/096212 A1, US 2006/0284788 A1, EP 3 473 497 B1 and FR 3 055 690.

The disadvantage here is that the lighting showcasing is primarily carried out using LEDS (light-emitting diodes) directly (for example line light in case of edges) or indirectly (for example ambient light on surfaces). However, this light always appears flat and even. The display used in the prior art discussed above takes up additional installation space and makes the display device heavier and more expensive. Creating a sense of depth, i.e. a 3D effect, in a lighting concept, especially in interior lighting, is very cost-intensive.

### SUMMARY

An object of the invention is to provide a more cost-effective and space-saving lighting system for a motor vehicle, in particular for the interior of the motor vehicle.

The invention is based on the idea of creating the illusion of a “hole” using a mirror effect without having to create a real hole. For this purpose, an “infinity mirror” is provided in the motor vehicle, i.e. an endless mirror which has a reflective surface of a first reflection element, for example a mirror, in one plane. This is combined with another reflection element that is at least partially transparent and partially opaque. The latter reflection element can, for example, have a semi-transparent mirror layer. In other words, the additional reflection element is not completely opaque. In the intermediate space formed by the two reflection elements, at least one light source is arranged, which is directed towards one of the two—or both—reflection elements. As a result, the light from the light source is reflected back and forth between the two reflective surfaces countless times. At the at least partially transparent reflection element, a part is allowed to pass through to the outside with each reflection, so that a light point is “multiplied” from the user's perspective. This creates the illusion of a hole flanked by light points, thus creating a depth effect.

A component on which such a lighting device is arranged appears to be “floating”. The mirror effect easily creates the depth effect of a hole without there actually being a hole. This allows the cladding concept to be simplified and also maintains the strength of the underlying structure. So no cutouts are necessary. This saves costs and reduces weight.

In contrast to the prior art described above, a lighting device according to the invention is designed as a light strip, which allows a higher degree of freedom in designs. In other words, according to the invention, no combination of a large-area design of the “endless mirror” is necessary, onto which a display outputs or projects a display content. Since the display is no longer necessary, installation space is saved, it is more cost-effective, and the weight of the lighting device is reduced. Another great advantage is that the light strip-shaped lighting device can also be used to easily illuminate and emphasize lines of edges in, for example, the interior of the motor vehicle.

A further advantage is that the strip-shaped design of the lighting element frees and emphasizes an adjacent application region. For example, a door opener, a switch or a rotary knob can be placed on this. If the light strip is designed as a curved strip, for example, the application region can be emphasized even better. This also creates much more degrees of freedom in the design of the illuminated application surface.

The motor vehicle according to the invention, for example a passenger car or a truck, has a lighting device arranged on the motor vehicle. This is to be understood in such a way that the lighting device can be arranged either outside the motor vehicle on the same motor vehicle or, in a preferred embodiment, in the interior on an interior trim element. An interior trim element is understood to be a part of the interior, i.e. a part of the interior trim, for example a door trim, a center console or a scoop.

The lighting device has a first flat reflection element which is arranged in a first reflection plane of the lighting device. A reflection element can be a component or part of a component that has a surface that reflects light. The first flat reflection element is arranged in a first reflection plane of the lighting device and is preferably fully opaque. The first flat reflection element can be, for example, a mirrored portion of an interior trim element, for example a chrome-plated, polished or gold-coated plastic part of the interior trim; or, for example, a mirror applied to a surface of the interior trim element.

The lighting device also has a second flat reflection element which is arranged in a second reflection plane of the lighting device and is spaced from the first reflection element. The second reflection element is designed to reflect light and is partially transparent. The second reflection element can, for example, be designed as a semi-transparent film or made of a Plexiglas layer. This means that the second reflection element is neither fully transparent nor fully opaque. The arrangement of both reflection elements is such that the part which shapes a strip of emitted light and which forms the light strip in the activated state is a region in which both reflection elements overlap at a distance. Both reflection elements are aligned to each other so that their reflecting surfaces face each other and form an intermediate space, i.e. they are spaced apart from each other.

The lighting device is arranged on the motor vehicle in such a way that the first reflection element is arranged on the motor vehicle when installed on the motor vehicle. The second reflection element is then facing the user. This means that the user looking at the lighting device sees the reflection points of the reflections of the reflection elements.

The lighting device has at least one lighting element which is arranged in the intermediate space in such a way that its light source is aligned with at least one of the two reflection elements. In other words, the at least one lighting element is arranged in the intermediate space in such a way that, when the lighting element is switched on, it emits light into the intermediate space and onto at least one of the two reflection elements. A lighting element is a component or group of components that is designed to emit light. Preferably, the lighting element can be designed as an LED. The lighting device may preferably comprise a plurality of lighting elements. Preferably, the lighting element can be aligned with the first reflection element, thereby achieving a stronger reflection.

The lighting device extends in a strip shape, i.e. it is designed as a light strip. In other words, the lighting device can form a light strip with the portion having the at least one lighting element. As a result, the mirror hole effect directs the depth effect of the endlessly reflected light onto the surface adjacent to the lighting device, for example the interior trim element, whereby the depth effect is directed and draws the user's attention to the adjacent surface.

The advantages mentioned above arise. A further advantage is a higher degree of freedom in the design of lighting concepts and in the implementation of control elements such as switches, buttons or door openers.

Preferably, the lighting device can form a curved light strip. This increases the depth effect and creates an at least partially outlined application surface on, for example, the interior trim element. In this preferred embodiment, the lighting device can form an at least partially bordered application region on a surface.

In a preferred embodiment of the motor vehicle according to the invention, a display device can be arranged on the surface of the motor vehicle component adjacent to the lighting device, a portion of the surface of, for example, the interior trim element, referred to below as the application surface. Preferably, this can be an at least partially bordered application surface, preferably wherein the lighting device can form a curved light strip.

A display device is understood to be a device, a device component or a device group that is designed to display digital image content. Accordingly, the display device can preferably be designed as a screen. For example, a small screen can be arranged within a closed light strip, or on an application surface that is partially surrounded by the light strip, or, for example, below the light strip. The combination creates a special shading effect that particularly emphasizes the image content output by the display device.

In a further embodiment of the motor vehicle, at least one operating element can be arranged on an application surface adjacent to the lighting device. An operating element is understood to be a component that is designed to receive an operating action and is integrated into or on the motor vehicle in such a way that a function is triggered by the received operating action. An operating element can be designed, for example, as a switch, a button, a window regulator, a touch-sensitive screen, or a capacitive proximity sensor. This combines the lighting concept with an operating concept and the operating element or several operating elements can be particularly highlighted by the lighting concept. These operating elements are particularly easy to locate at night.

Preferably, the lighting device can be arranged on an inside of a door of the motor vehicle. The advantages already mentioned arise. Additionally, optional operating elements or screens are highlighted so they are easy to find, especially at night, but are not directly in the driver's field of vision when looking at the road. Such a lighting concept is particularly advantageous if a door opening handle is arranged on the at least partially bordered application surface.

Preferably, the first reflection element can be designed as a mirror. This creates a particularly strong depth effect.

In a further embodiment of the motor vehicle according to the invention, the second reflection element can be designed, for example, as frosted glass or partially opaque film. The light point of the lighting element or light points of multiple lighting elements blur due to light refraction and the individual light points merge into one another. This creates a particularly beautiful lighting effect.

According to further embodiments of the motor vehicle according to the invention, the first reflection element can be a surface of an interior trim element of the motor vehicle, or a surface of the body of the motor vehicle.

As an alternative to the latter embodiment, the lighting device can be arranged on an interior trim element of the motor vehicle or on an outer side of the body of the motor vehicle.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a first exemplary embodiment of the motor vehicle according to the invention;

FIG. 2 shows a schematic representation of the principle of the lighting device and of a further exemplary embodiment of the motor vehicle according to the invention;

FIG. 3 shows a schematic representation of a third exemplary embodiment of the motor vehicle according to the invention;

FIG. 4 shows a schematic representation of a fourth exemplary embodiment of the motor vehicle according to the invention; and

FIG. 5 shows a schematic representation of a fifth exemplary embodiment of the motor vehicle according to the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

The individual embodiments described below can be combined with each other in any combination.

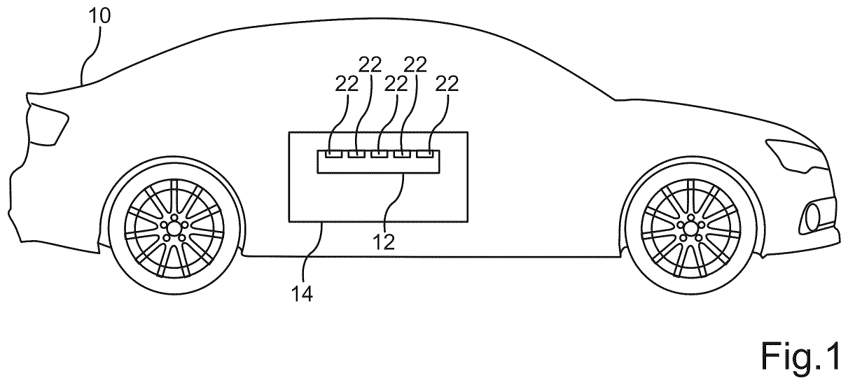

FIG. 1 schematically illustrates an example of a motor vehicle 10, for example a passenger car, which has a lighting device 12 designed as a light strip. Alternatively, the lighting device 12 can form the light strip only with the portion with the lighting elements 22, or a predominant portion with lighting elements 22 forms the light strip. The lighting device 12 designed as an endless mirror can be arranged, for example, on an outer side of the motor vehicle 10, i.e. on a body of the motor vehicle 10, or preferably on an interior trim element 14, for example an inner door trim. In this case, either a portion of a surface of the interior trim element 14 or a surface on the outside of the body of the motor vehicle 10 can form the first reflection element (not shown in FIG. 1), or the lighting device 12 can be arranged on the interior trim element 14 or on the outside of the motor vehicle 10, for example glued, screwed or welded.

FIG. 1 schematically shows that the lighting device 12 is designed in the shape of a strip, i.e. when switched on it has the shape of a light strip.

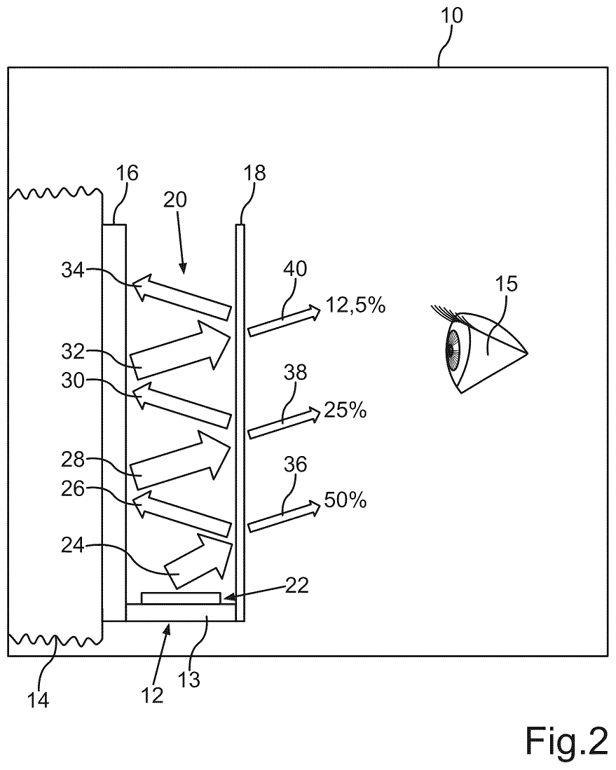

FIG. 1 schematically illustrates the structure of the lighting device 12 and shows a cross section. The motor vehicle 10 indicated schematically in FIG. 2 can preferably be the motor vehicle 10 of FIG. 1.

For illustration purposes, FIG. 2 shows an eye 15 of a user of the motor vehicle 10, for example an occupant. The size relationships between the eye 15 and the lighting device 12 are not to scale. The eye 15 serves only for orientation purposes to illustrate the direction from which a user sees the lighting device 12 and the corresponding orientation in which the lighting device 12 is arranged.

In this example, the arrangement of the lighting device 12 on an interior trim element 14 of the motor vehicle 10 is shown as an example, for example on an interior door trim. In addition, in FIG. 2 the example is chosen in which the first reflection element 16 is arranged on the interior trim element 14. Alternatively, however, a mirrored, chrome-plated, gold-plated or polished surface of the interior trim element 14 can form the first reflection element 16. Optionally, the lighting device 12 may have a frame 13 that frames the intermediate space 20.

The first reflection element 16 and the second reflection element 18 form an intermediate space 20 in which, for reasons of better clarity and due to the perspective of the cross section in FIG. 2, only one lighting element 22 can be seen. Ideally, however, the lighting device 12 may comprise a plurality of lighting elements 22, which are arranged, for example, along a longitudinal extent of the lighting strip. In the example, the exemplary lighting element 22 shown can be designed as an LED, for example, and emit light directly into the intermediate space 20. In this embodiment, the lighting element 22 can also emit the light onto both reflection elements 16, 18.

The endless mirror provided in the motor vehicle 10 according to the invention is designed as a light strip, for example as a straight light strip as shown by way of example in FIG. 1, or as a curved light strip.

FIG. 2 illustrates, with arrows 24, 26, 28, 30, 32, and 34, the path of the light from the lighting element 22 within the intermediate space 20. A long this path, for example, 100 percent (24) of the light can be emitted onto the second reflection element 18, of which 50 percent (26) can then be reflected back onto the first reflection element 16; and during the reflections between the first and second reflection elements 16, 18, the reflection can then be 50 percent (28), 25 percent (30), 25 percent (32), and 12.5 percent (34).

The first reflection element 16 can, for example, be designed as a mirror, wherein the mirror surface is oriented towards the intermediate space 20. Preferably, the first reflection element 16 can be fully opaque on its mirror surface. The second reflection element 18 can preferably be designed as a semi-transparent mirror layer, for example as a semi-transparent mirror film. The second reflection element 18 may preferably have a degree of transparency in a range of 10 percent to 30 percent. The lower the degree of transparency, the darker the light is from the user's perspective. With a higher degree of transparency, the mirror effect is also reduced.

With an optional design of the second degree of reflection as frosted glass or cloudy film, the individual light points disappear due to light refraction and merge into one another. If the second reflection element 18 is not designed as a cloudy film or frosted glass, the user sees a plurality of individual light points which appear gradually weaker towards an end of the lighting device 12 opposite the lighting element 22. In FIG. 2, the arrows 36, 38, 40 illustrate the light points shining through the second reflection element 18, wherein the first visible light point (36) can have a brightness of 50 percent of the lighting element 22, the virtual light point (38) only 25 percent and the next light point (40) only 12.5 percent. The longer the illumination device 12 and the row of lighting elements 22 extend in width, the more light points the user sees, wherein each light point that appears further away from the lighting element 22 can have a brightness 50 percent lower than the previous virtual light point.

In a longitudinal extension of the lighting device 12, the individual lighting elements 22 can be arranged depending on the design requirements or intended lighting concept. In the example of FIG. 1, five lighting elements 22 are shown as an example. Alternatively, a lighting element 22 can also be designed as a linear light or light bar.

Optionally, the lighting device 12 may comprise a power source (not shown in the figures).

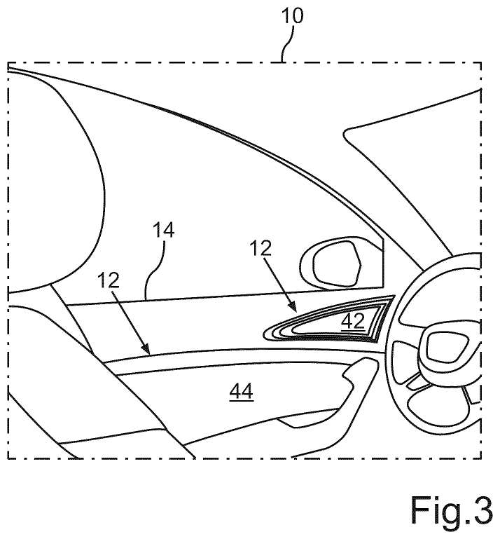

FIG. 3 shows a further exemplary embodiment of the motor vehicle 10 according to the invention, which can preferably be combined with the exemplary embodiments of FIG. 1 and/or FIG. 2. In this example, the interior door panel is again selected as the interior trim element 14. In this example, two lighting devices 12 are shown, wherein this can form a closed border of a first application surface 42, and wherein the other can be designed linearly, for example to emphasize an edge. In both lighting devices 12, the endless mirror effects are illustrated by the fact that the light strip is characterized by multiple borders. These multiple borders or parallel lines thus illustrate the multiple reflected light of multiple lighting elements 22. Each of the lighting devices 12 can, for example, have so many lighting elements 22 that the total light can appear as a solid line. Alternatively, each of these lines may appear as a dotted line. In the first lighting device 12, which surrounds the application surface 42, each light point or each light line can, for example, appear as a triple reflection. In the second lighting device 12, which can be arranged above an application surface 44, each of the light lines can be mirrored four times, for example.

In the example of FIG. 3, the mirror effect on the door is shown, wherein, for example, the two application surfaces 42, 44 can be free of other components.

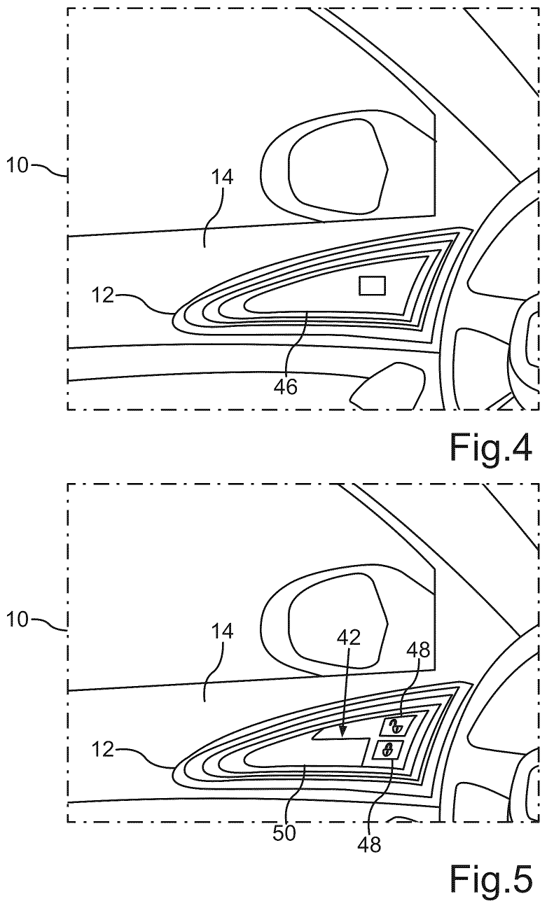

FIG. 4 and FIG. 5 show embodiments which can each be combined with one or more embodiments described here, wherein only one lighting device 12 is shown on the exemplary door interior panel in FIG. 4 and FIG. 5. For the sake of clarity, the reflections of the light are shown in the example as four light lines surrounding the application surface 42. In the example of FIG. 4, a central display device 46 can be arranged on a central application surface 42, which display device can preferably be designed as a screen (“display”). The exemplary central display can, for example, be designed as a touch-sensitive screen on which symbols for adjustment options for the exterior mirrors or the exterior mirror can be displayed. By touching one of the exemplary arrows for adjusting the exterior mirror, the touch can be received as an operating action, for example by a control unit of the motor vehicle 10, and the exterior mirror can be adjusted accordingly. In this case, the display device 46 can also be referred to as an “operating element”.

FIG. 5 shows an embodiment in which two operating elements 48 can be arranged in the application surface 42, for example two operating elements for opening or closing the motor vehicle, as well as a door opening handle 50. The operating elements 48 can be designed, for example, as buttons or switches or push buttons.

Overall, the examples show how an interior trim element of a motor vehicle, for example a door, can be provided with a mirror hole effect.

In addition to the advantages already mentioned above, the mirror effect easily creates the depth effect of a hole without there actually being a hole. This means, for example, that the trim concept can be simplified and the strength of the underlying structure is maintained (no recesses necessary). This provides cost savings and reduces weight.

In a further preferred technical implementation (FIG. 2), the light is always sent back and forth between the two reflection elements 16, 18, for example between the mirrors or between a mirror and a semi-transparent mirror, and each time loses some luminosity, and some light escapes, which provides the infinity mirror with its depth effect. The user has the feeling of looking into a deep tube.

Basically, the technology of an infinite mirror is used.

In a further preferred exemplary embodiment (FIG. 3), two endless mirror elements are shown as lighting devices 12 with a circumferential LED strip and central application surface 42, 44. In FIG. 3 the mirror effect is thus shown in or on the door.

FIG. 4 shows a further embodiment variant of the endless mirror element, i.e. the lighting device 12, with, for example, a central application surface 42, 44, in or on which, for example, a central display can be arranged, for example with adjustment options for the exterior mirror. FIG. 6 shows an embodiment variant of the endless mirror element with, for example, a central application surface 42, in or on which an integration of a door opening handle 50 and, for example, two operating elements 48, for example two buttons, for door locking can be arranged.

For fastening the mirror element—i.e. the lighting device 12—in the respective exemplary embodiments, it can be provided, for example, that it can be rigidly connected on one side to the exemplary door shell structure. For this purpose, for example, a direct connection to the shell or an indirect connection using a special holder are possible. On the other hand, the mirror element—i.e. the lighting device 12—can also be attached to the exemplary door trim. Thus, the lighting device 12 is part of the trim, which facilitates installation during production. Optionally, the lighting device 12 may be made entirely or partially of or comprise Plexiglas, which allows for additional elasticity.

In a preferred embodiment (for example FIG. 3), multiple lighting elements 22, preferably LEDs, can be positioned circumferentially around, on or in the lighting device 12. This highlights the central application surface 42 and makes it appear to be floating. The central application surface 42 can be used for various applications. Here, operating and display elements such as a door opening handle 50, operating elements 48 such as buttons or switches, and/or one or more display devices, preferably one or more displays, can preferably be integrated (see FIG. 5).

Furthermore, the lighting elements 22 can be positioned only on one side of the lighting device 12. This can be used as a kind of line light for edges or design lines.

The structure of the lighting device 12 is shown as an example in FIG. 2. The lighting device 12 may preferably have a glass or plexiglass layer as the second reflection element 18, wherein the two cover surfaces may be designed as a fully and semi-transparent mirror. For example, an LED strip can be installed on the outer edge to achieve the greatest possible effect. This exemplary LED strip can optionally vary in color and/or brightness.

In a preferred control of the lighting device 12, it can be activated, for example, directly by the occupant and/or automatically by the motor vehicle 10. For example, activation can occur when approaching and/or when unlocking.

The lighting device 12 can, for example, remain activated while driving, or can, for example, switch off after a certain time. The control can preferably be networked with the ambient light control.

Further advantages are that the endless mirror effect creates both a depth effect and an out-fading effect without having to use a large number of lighting elements 22. This is cost-effective and requires less space than, for example, a conventional LED network or display. Furthermore, the display changes slightly when you change your viewing direction (for example by moving your head). This creates additional fascination and novelty.

The inventive concept is to create the illusion of a hole using a mirror effect without having to create a real hole. This allows for depth effects and makes components appear to “float”.

1. A motor vehicle with a lighting device which is arranged on the motor vehicle, and which comprises:
a first flat reflection element arranged in a first reflection plane of the lighting device,
a second flat reflection element arranged in a second reflection plane and spaced from the first reflection element, wherein the second reflection element is designed to reflect light and is partially transparent,
wherein both reflection elements are aligned with each other such that their reflecting surfaces face each other and form an intermediate space, and wherein the first reflection element is arranged on the motor vehicle;
wherein the lighting device has at least one lighting element which is arranged in the intermediate space in such a way that, when switched on, it emits light onto at least one of the two reflection elements; and
wherein the lighting device forms a light strip.

2. The motor vehicle according to claim 1, wherein the lighting device forms a curved light strip.

3. The motor vehicle according to claim 1, wherein a display device is arranged on an application surface adjacent to the lighting device.

4. The motor vehicle according to claim 1, wherein at least one operating element is arranged on an application surface adjacent to the lighting device.

5. The motor vehicle according to claim 1, wherein the lighting device is arranged on an inner side of a door of the motor vehicle.

6. The motor vehicle according to claim 5, wherein a door opening handle is arranged on the at least partially bordered application surface.

7. The motor vehicle according to claim 1, wherein the first reflection element is designed as a mirror.

8. The motor vehicle according to claim 1, wherein the second reflection element is designed as frosted glass or partially opaque film.

9. The motor vehicle according to claim 1, wherein the first reflection element is a surface of an interior trim element of the motor vehicle, or is a surface of the body of the motor vehicle.

10. The motor vehicle according to claim 1, wherein the lighting device is arranged on an interior trim element of the motor vehicle or on an outer side of the body of the motor vehicle.

11. The motor vehicle according to claim 2, wherein a display device is arranged on an application surface adjacent to the lighting device.

12. The motor vehicle according to claim 2, wherein at least one operating element is arranged on an application surface adjacent to the lighting device.

13. The motor vehicle according to claim 3, wherein at least one operating element is arranged on an application surface adjacent to the lighting device.

14. The motor vehicle according to claim 2, wherein the lighting device is arranged on an inner side of a door of the motor vehicle.

15. The motor vehicle according to claim 3, wherein the lighting device is arranged on an inner side of a door of the motor vehicle.

16. The motor vehicle according to claim 4, wherein the lighting device is arranged on an inner side of a door of the motor vehicle.

17. The motor vehicle according to claim 2, wherein the first reflection element is designed as a mirror.

18. The motor vehicle according to claim 3, wherein the first reflection element is designed as a mirror.

19. The motor vehicle according to claim 4, wherein the first reflection element is designed as a mirror.

20. The motor vehicle according to claim 5, wherein the first reflection element is designed as a mirror.
